(19) United States
(12) Patent Application Publication
(10) Pub. No.: US 2004/0184540 A1
(43) Pub. Date: Sep. 23, 2004

(54) Data processing system, data processing apparatus and data processing method

(76) Inventors: Tsuyoshi Miura, Kawasaki (JP); Seiichi Kakinuma, Kawasaki (JP); Shin Fujita, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/792,327

(22) Filed: Mar. 2, 2004

(30) Foreign Application Priority Data
Mar. 19, 2003 (JP) 2003-076336

(51) Int. Cl. H04N 7/12

(52) U.S. Cl. 375/240.12; 375/240.25

(57) ABSTRACT

A data processing system includes: a data transfer rate converting part converting a data transfer rate a predetermined coded data stream; a time information updating part updating time information which the predetermined coded data stream has according to a data transfer rate conversion ratio applied in the data transfer rate converting part; and a decoding device decoding the coded data stream for which the data transfer rate has been converted by the data transfer rate converting part and the time information is updated by the time information updating part, and wherein: the decoding device decodes the coded data stream for which the data transfer rate has been thus converted in timing according to the time information which has been thus updated by the time information updating part.

### BACKGROUND OF THE INVENTION

1. Field of the Invention

The present invention relates to a data processing system, a data processing apparatus and a data processing method, and, in particular, to a data processing system, a data processing apparatus and a data processing method for mainly processing a data stream such as moving picture data or so.

2. Description of the Related Art

Recently, digital signal processing technology has made remarkable progress, and, along therewith, development has been proceeded with worldwide for a system achieving digital broadcast, and fusion between broadcast and communications. In this term, the most essential technology is a technology of compressing video/audio data. As the compression technology, for example, a coding compression method standardized in MPEG (Moving Picture Experts Group) exists. For this coding compression method, study has been proceeded with for achieving worldwide technical standardization of broadcast, communications and storage media.

Further, recently, an image dispatch service has been developed with a use of various types of wide-area communication networks such as the Internet, and so forth. In many cases, such an image dispatch service applies a stream dispatch method utilizing the above-mentioned MPEG standard. For achieving such data dispatch handling a large size of data such as image data, the communication network applied should have a transmission band providing a large communication capacity. However, in general, as the infrastructure is limited with respect to the increasing demand for the communications, a transmission band providing a sufficient communication capacity cannot be prepared in some case. Furthermore, a common communication network is made by various types of transmission channels of various transmission bands such as a LAN, an SDH, an ISDN, a public circuit, and so forth. In such a various types of communication networks, in some case, different transmission bands are included in a transmission path from an information transmission source through a transmission destination.

In such a situation, in case a transmission band applied is narrower than a coded rate of information coded in the information transmission source, real-time video reproduction may not be provided at the transmission destination. In such a case, at the transmission destination, video reproduction can be started after all the MPEG steam has been completely received, and thus, the real-time feature of the video data is remarkably degraded. Furthermore, in such a case, the receiving processing should not be interrupted until the entire MPEG stream has been received. As a result, the transmission destination may be needed to receive even a part of video data which is not actually required. Furthermore, in case where there are a plurality of transmission sources, and a user selects a desired transmission source therefrom, some inconvenient situation for the user may occur if it is necessary to receive all the data stream before reproducing it as mentioned above.

Japanese laid-open patent application No. S64-57887 discloses a method in which a process is repeated in each of which data is received and stored for a predetermined time interval and reproduction is performed on each of the thus-stored parts of data. However, in this method, video reproduction is interrupted frequently, and thus, a sufficiently high image quality may not be secured.

In a case where MPEG stream dispatch is performed in such a system, a transcoder is inserted between the transmission source apparatus and the transmission destination apparatus, in some case. The transcoder is applied for converting a bit rate of a data stream appropriately according to a data transmission band of a communication channel applied for transmission of the data stream. In other words, in case where a digital signal of video/audio which is coded and compressed is transferred through transmission media having different bit rates, bit rate conversion is performed appropriately according to the bit rates of the respective particular transmission media.

Conventionally, a stream which is compressed and coded according to the MPEG standard is received by the above-mentioned transcoder apparatus, which once decodes the stream into an original image signal or so, and, after that, encodes and compresses again the thus-obtained image signal or so according to the MPEG standard according to a bit rate applied for the transmission destination apparatus. Then, after that, data transmission is performed at the bit rate suitable to the transmission band for the transmission destination. However, in such a method, at the transmission destination, the received data is again decoded so as to return to the original image signal or so before reproducing it. Accordingly, for the data stream, MPEG coding/decoding processing is respectively performed, and thus, the video quality may be remarkably degraded.

Japanese laid-open patent application No. H11-177986 discloses another method for transmitting from a wide band network through a narrow band network, in which only I pictures are transmitted. This method is a method in which only I pictures from among I pictures (intra-frame coded images), P pictures (inter-frame forward-directional predictive coded images) and B pictures (both-directional predictive coded images) according to the MPEG standard, are extracted, and then, are transmitted through the narrow band network. According to this method, only the I pictures, for which decoding can be made independently and having a high image quality, in comparison to the P and B pictures, are transmitted, without transmitting the P and B pictures, and thus, transmission capacity required can be effectively reduced. However, in this method, the pictures other than the I pictures are discarded.

For example, in a technical field of a moving picture dispatch in a network of monitoring system monitoring through the network for a predetermined event, which field has been being developed recently, if the conventional method is applied in which encoding is performed again according to a band width of a narrow band network applied, the image quality may be degraded as mentioned above since high rate image compression is performed. On the other hand, in case of applying the above-mentioned method of transmitting only the I pictures, the frames reproduced from themselves have a high image quality. However, in this case, as the P and B picture frames are thinned out as mentioned above, the images actually reproduced include only intermittent ones from the I pictures as a result, and, thus, there is a possibility that some important frames in terms of a predetermined monitoring purpose may be omitted. For example, in case of traffic accident monitoring system, a frame of a moment in which a traffic accident actually occurred, a frame clearly showing a number plate of a escaping vehicle, or so, may be omitted, or, in case of shop/store anticrime monitoring system, a frame of a just moment in which a criminal person committed a crime may be omitted, or so. In case of a moving picture dispatch processing system applied to such a monitoring system for which omission of frames is not permitted, it is demanded that each frame has a high image quality, frame thinning out is not performed, and also, at a reception end, frame reproduction may be performed in a real-time manner to the utmost extent.

Thus, in case of performing data dispatch after converting a bit rate according to an available band in an MPEG stream dispatch system employing a transcoder with a user of a network having a limited available band, information finally transmitted from a transmission source is reduced before being reproduced at a transmission destination any case in which a spatial compression in which image resolution or image quality is reduced, or a temporal compression in which the number of frames is reduced for unit time interval while remaining frames are reproduced at high image quality, in other words, frames are thinned out is applied there.

### SUMMARY OF THE INVENTION

The present invention has been devised in consideration of the above-mentioned situation, ands an object of the present invention is to provide a data transmission processing system by which, when a data stream is transferred with a use of an insufficient information transmission band, the information of the data stream is not reduced, and also, reproduction can be performed at a transfer destination with a real-time feature to the utmost extent.

In order to achieve the object of the present invention, according to the present invention, time information of a data stream is updated according to a conversion of a data transfer rate, and, upon decoding the transfer-rate-converted data stream, decoding is performed according to the time information which is thus updated. By applying this manner, even arrival of data at a transfer destination is delayed due to a reduction in an available data transfer capacity, the time information of the data is previously extended (updated) as mentioned above with an anticipation of such an arrival delay. Thereby, as long as decoding is performed according to the time information which is thus extended, it is possible to avoid mismatch winch otherwise would occur between time progress according to a reference clock signal in a decoding apparatus at the destination end and the time information of the relevant data to be decoded therewith.

Specifically, in case of transmitting an MPEG stream or so from a wide band network into a narrow band network, time information which the MPEG stream has is changed according to the constriction rate in the transmission band of the applied network for example. Thereby, it is possible to dispatch the contents of video stream with a high image quality at a reduced delay (without waiting for the completion of reception of the entire data even having a large size). Furthermore, as the bit rate conversion is performed without thinning out of any frames, it is possible to provide an actual display of the video contents at a receiving apparatus simultaneously with a transmission start time at a transmission apparatus even through a narrow band network. As a result, it is possible to receive all the frames which are transmitted without fail, and then, to positively reproduce a video display thereof.

According to the present invention, the time information of transfer data is updated to be extended according to a reduction rate in a data transfer rate which is limited according to an available transmission band/capacity of a data transmission path. Thereby, in a data transfer destination, as long as the received data is processed according to the thus-updated time information, it is possible to always execute predetermined data processing such as decoding and reproduction properly.

Especially in a case where a data stream such as video data is processed, video has a characteristic such that a human being viewer can figure out the information contents properly even if a reproduction rate is slowed down as long as reproduction is performed without thinning out of any frames of the video data. By utilizing this characteristic, according to the present invention, data dispatch is performed after the time information of the data stream is appropriately extended or shifted forward and thus updated. Thereby, at the receiving end, by executing even a common manner of decoding and reproduction processing, it is possible to achieve reproduction of moving pictures immediately after it is received as long as the reproduction is performed according to the thus-updated time information.

### BRIEF DESCRIPTION OF DRAWINGS

Other objects and further features of the present invention will become more apparent from the following detailed description when read in conjunction with the accompanying drawings:

FIG. 1 shows a system configuration of each embodiment of the present invention;

FIG. 2 shows a block diagram of an MPEG encoder shown in FIG. 1;

FIG. 3 shows a block diagram of an MPEG transcoder shown in FIG. 1;

FIG. 4 shows a block diagram of an MPEG decoder shown in FIG. 1;

FIG. 5 shows an operation flow chart of a reception sequence in the transcoder shown in FIG. 3;

FIG. 6 shows an operation flow chart of a transmission sequence in the transcoder shown in FIG. 3;

FIG. 7 shows an operation flow chart of a time information updating sequence in the transcoder shown in FIG. 3;

FIG. 8 shows an operation flow chart of a picture deletion sequence in the transcoder shown in FIG. 3;

FIG. 9 shows an operation flow chart of a receiving sequence in the decoder shown in FIG. 4;

FIGS. 10, 11, 12, 13, 14 and 15 illustrate a data stream format in a data stream according to MPEG 2;

FIGS. 16 and 17 illustrate numerical example in updating of time information in an MPEG steam according to each embodiment of the present invention; and

FIG. 18 illustrates change in reproduction rate according to updating of time information in an MPEG steam according to each embodiment of the present invention.

### DETAILED DESCRIPTION OF THE PREFERRED EMBODIMENTS

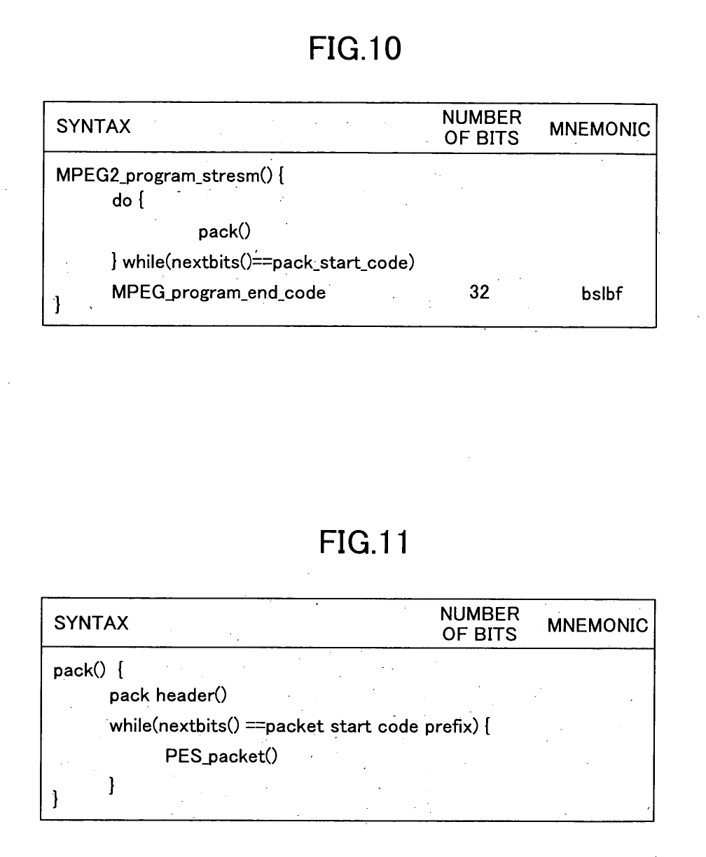

An outline of a first embodiment of the present invention will now be described. First, a data structure of an MPEG stream will now be described. An MPEG system integrates a coded stream such as MPEG video data, MPEG audio data or so including synchronization information (or time information) therefor. With regard to the MPEG system, FIGS. 10, 11, 12, 13, 14 and 15 illustrate syntaxes of the data format of an MPEG 2 stream according to the recommendation H.222.0, which is a standard book for the MPEG 2.

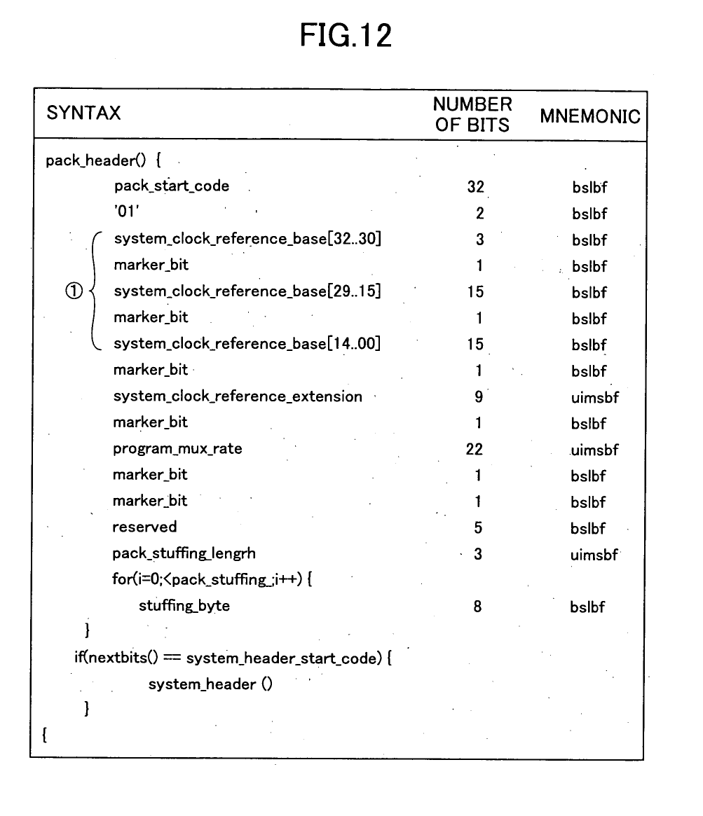

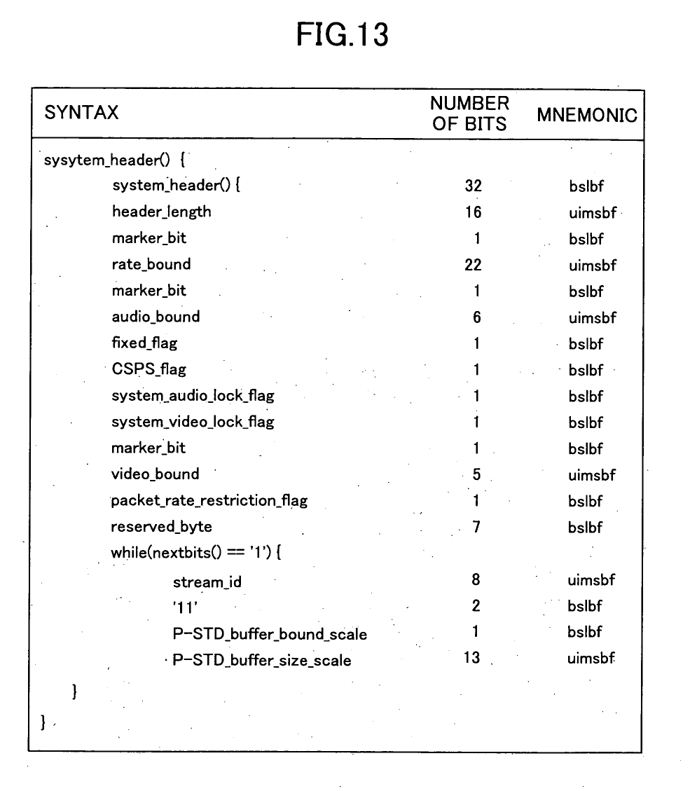

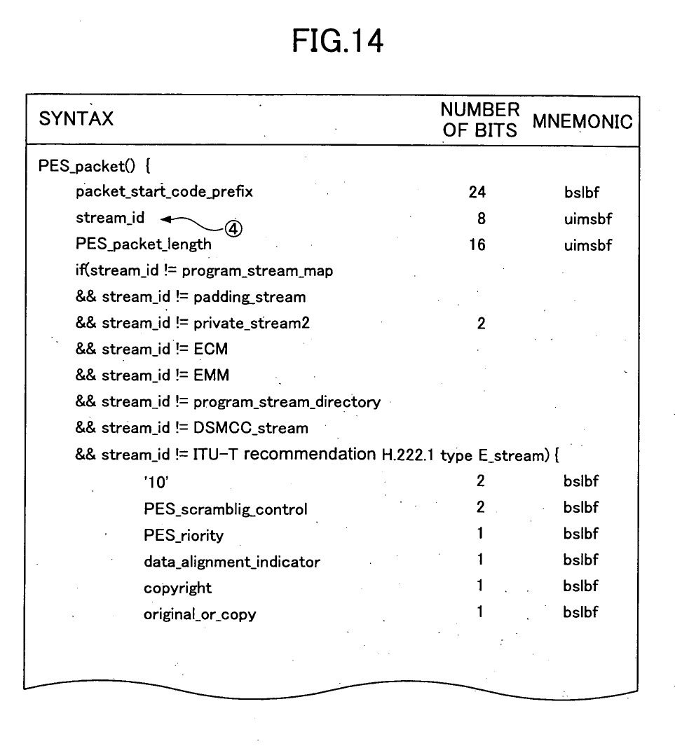

As shown, the MPEG system includes a higher layer (pack layer) and a lower layer (packet layer). The pack layer includes pack headers (FIG. 12 shows a syntax of the pack header), and, in the pack layer, system headers (FIG. 13 shows a syntax of the system header) and packets (FIG. 14 shows a syntax of the PES packet) are included.

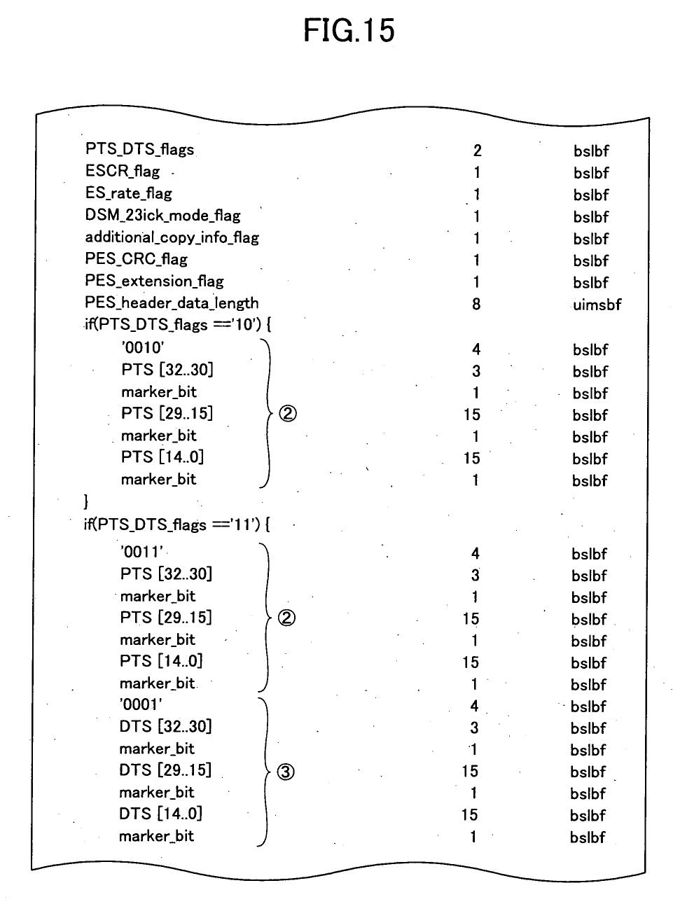

In the MPEG stream, for the purpose of synchronization at a time of reproduction thereof, a time reference value SCR (System Clock Reference; \mathring{1} in FIG. 12) is set in the pack header. In each packet, time management information PTS (Presentation Time Stamp; \mathring{2} in FIG. 15) for reproduction output and time management information DTS (Decoding Time Stamp; \mathring{3} in FIG. 15) for decoding are set. A decoding apparatus which receives the MPEG stream has a synchronization signal (referred to as ‘SystemClock’, hereinafter) as time reference, sets the value of SCR of the received stream in the SystemClock, and therewith, the SystemClock is calibrated appropriately.

The above-mentioned DTS and PTS are set for each decoding and reproduction unit (each frame for video data; and each audio frame for audio data). By a predetermined ‘PTS % DTS flag’, it is determined whether or not a relevant packet has a PTS/DTS. In a decoder or decoding apparatus, when the SystemClock has a value of DTS of the packet, decoding of the packet is executed, and, when the SystemClock has a value of PTS of the packet, the packet is reproduced. As a result, synchronization with a coding end (apparatus) and synchronization between audio data and video data are achieved.

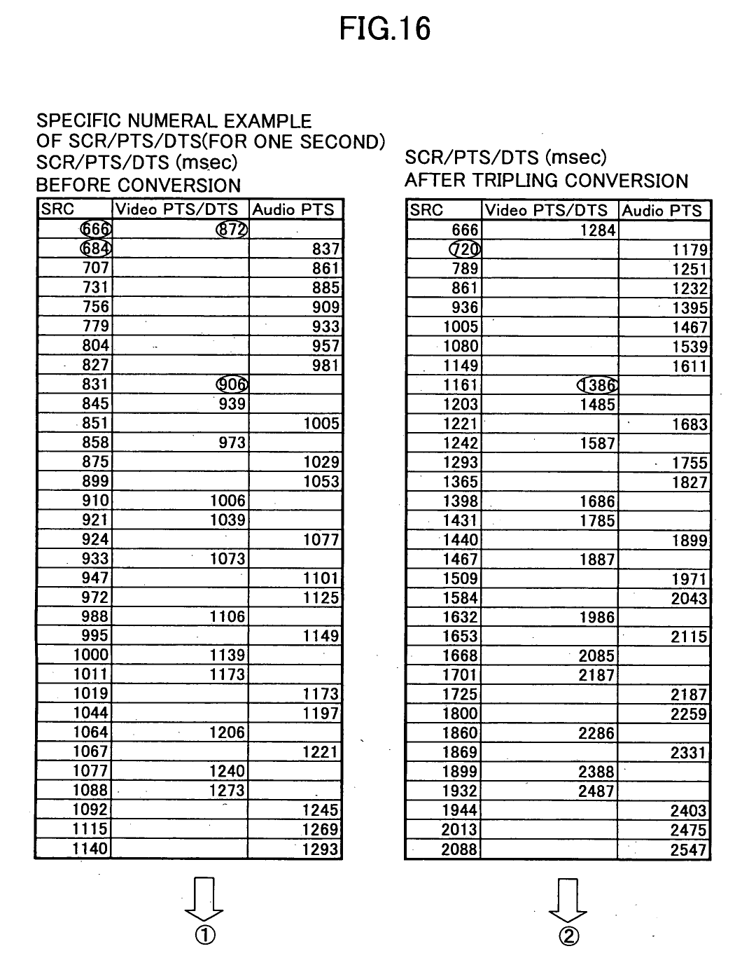

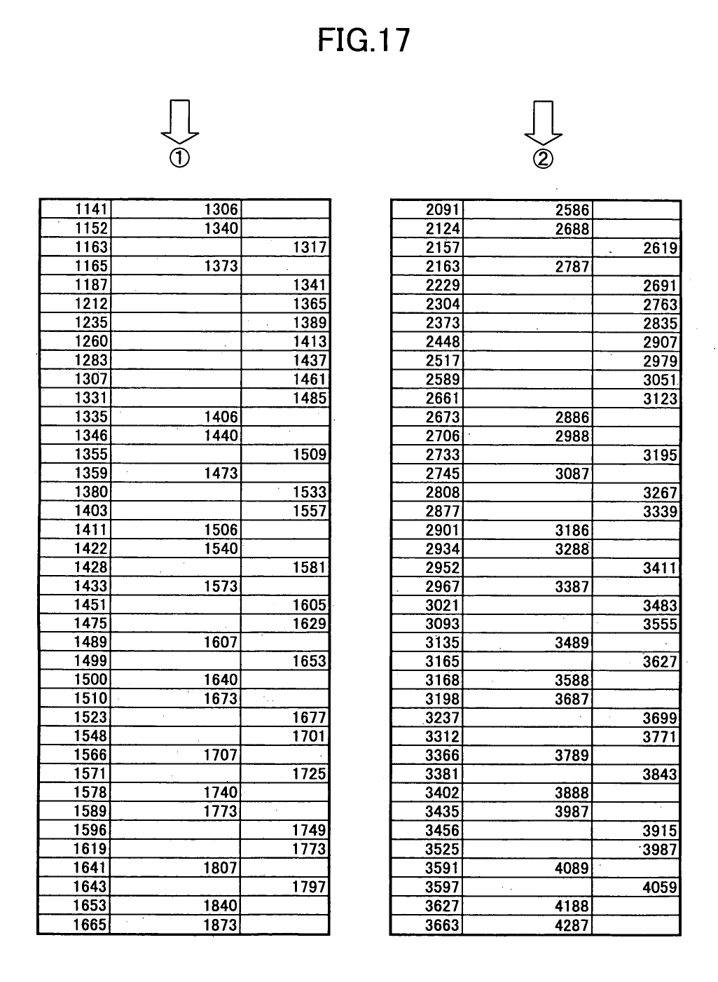

For example, left-hand tables in FIGS. 16 and 17 show numerical examples of common SCR, PTS and DTS set in an MPEG stream. In each table, the top correspond to the initial part of the stream, and, lower subsequent parts of the table correspond to subsequent parts of the stream, respectively, in sequence. As the value of the first SCR in this case is 666 msec., and at this time, the SystemClock is thus set as 666 msec. After that, the SystemClock is updated according to the progress of the actual time with reference to the time 666 msec. Then, when the time indicated by the SystemClock reaches 872 msec., video frame data included in a PES packet having the same value 872 msec. in Video PTS/DTS, shown in FIG. 16, is decoded and reproduced. After that, the SystemClock is updated similarly, and then, when the SystemClock has the time value of 906 msec., a subsequent relevant image frame, shown, is decoded and reproduced. Similarly, after that, according to the progress in the time value of the SystemClock, corresponding image frames are decoded and reproduced, in sequence.

It is assumed that the entire MPEG stream received by a transcoder is then dispatched through a narrow band network. In this case, if the given MPEG stream is transmitted through the narrow band network as it is, as the data transfer rate is reduced with respect to the band constriction rate, times at which respective image frames arrive at a transmission destination are accordingly delayed one by one gradually. As a result, in the transmission destination decoder apparatus, mismatch occurs between the above-mentioned SystemClock and the values in SCR/PTS/DTS of the received stream. As a result, proper decoding processing may not be achieved due to the above-mentioned mismatch.

That is, in the example shown in FIG. 16, left-hand table, when the stream is received first, the SystemClock is set as 666 msec. which is the value of SCR. After that, the first image frame having the PTS/DTS value of 872 msec. is received and reproduced when the SystemClock has the same value. After that, it is assumed that the arrival of the subsequent frame data is delayed as mentioned above due to the narrower band. In this case, a situation may occur in which, even when the SystemClock then has the value of 906 msec., the image frame data having the same value in PTS/DTS has not yet arrived at this decoder. In this case, mismatch occurs between the PTS/DTS value of the data which has already arrived and thus can be processed and the current value in the SystemClock. In order to avoid such mismatch which occurs between the SystemClock and the value in SCR, PTS and DTS during decoding and reproduction, a countermeasure should be taken in which, for example, the entire stream is once received, and stored, and after that, decoding and reproduction of the stored data are started. Thus, the real-time feature upon decoding and reproduction of dispatched data is remarkably degraded.

According to the first embodiment of the present invention, in order to solve this problem, in a transcoder which dispatches a stream through a narrow band network, the values in the SCR/PTS/DTS of the stream are previously updated into delayed time values suitable for a decoder which then receives this stream through the narrow band network, and decodes and reproduces it. By applying this scheme, in the decoder, after receiving the stream through the narrow band network, the received video/audio data can be immediately reproduced in timing according to the thus-updated SCR/PTS/DTS frame by frame.

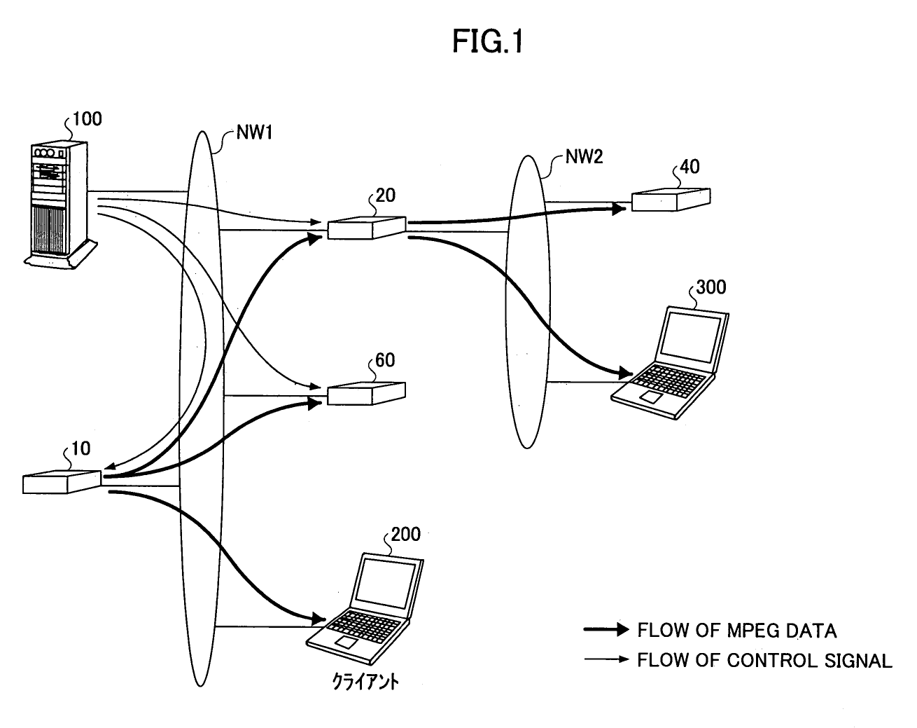

FIG. 1 shows a block diagram illustrating a system configuration of an MPEG stream dispatch system employing an MPEG decoder in the first embodiment of the present invention. In this system, as communication networks applied, a wide band network NW1 of 6 Mbps and a narrow band network NW2 of 2 Mbps are assumed. To the wide band network NW1, an MPEG encoder 10 which dispatches an MPEG stream in a live manner, an MPEG transcoder 20 which once receives the stream from the MPEG encoder 10 and then dispatches it through the narrow band network NW2, an MPEG decoder 60 and a client 200 which receive/decode/reproduce the stream received from the MPEG encoder 10, and a server 100 which performs control and setting of coding modes, live dispatch addresses, and so forth for the MPEG encoder 10, the MPEG transcoder 20, or so, are connected.

To the narrow band network NW2, the above-mentioned MPEG transcoder 20 which receives the stream from the MPEG encoder 10 connected to the wide band network NW1, and dispatches it then through the narrow and network NW2, and an MPEG decoder 40 and a client 300 which receive/decode/reproduce the stream from the MPEG transcoder 20 through the narrow band network, are connected.

In this system, the server 100 controls all the apparatuses connected to the wide band network NW1. In other words, it sets a coding mode (MPEG 1/2/4, coding bit rate, designating whether or not audio is included, or so), a live dispatch address or so, for the MPEG encoder 10. Further, for the MPEG transcoder 20, the server 100 sets a live receiving address, a live dispatch address with which a received MPEG stream is then dispatched through the narrow band network NW2. Furthermore, the server 100 sets a live receiving address for the MPEG decoder 60, the client 200, or so.

The MPEG encoder 10 is located at a place at which the server 100 can monitor it, encodes input video data in a set coding mode, and dispatches the thus-obtained MPEG stream to an address set by the server 100. The MPEG transcoder 20, the MPEG decoder 60 and the client 200 is installed at an office or a monitoring center. The MPEG transcoder 20 has at least two types of network interfaces, performs data conversion on an MPEG stream received through the wide band network NW1, and dispatches it then through the narrow band network NW2. In the MPEG decoder 20 or the client 200, by decoding and reproducing a received MPEG stream, monitoring for a predetermined event occurring at a remote location can be executed.

Each of the MPEG decoder 40 and the client 300 connected to the narrow band network NW2 is installed in a headquarter office, a satellite office, a home of a user, or so. Setting of the live receiving addresses for these apparatuses (i.e., live dispatch addresses in the MPEG transcoder 20) is performed by each client terminal 200. Furthermore, in the MPEG decoder 40 or the client 200, by decoding and reproducing a received MPEG stream, monitoring with a use of monitoring video transmitted from the encoder 10 of so through the wide band network NW1 can be achieved by a predetermined watch person.

Thus, it is assumed that the moving picture dispatch system according to the first embodiment of the present invention is applied to a monitoring system in which a possible predetermined event is pick up by a TV camera or so, not shown, and video data thus obtained is used for the monitoring work. In this monitoring system, a specific event, such as a traffic accident on a road, an illegal intruder in a shop/store, a siren sound or so, is detected by a predetermined detecting system, not shown, for example, an image sensor, a voice sensor, a millimeter-wave sensor, or so, installed in a location which should be managed, thus, event occurrence information is generated therewith, and the information is provided to the encoder 10 in a form of a monitoring signal. Simultaneously, video data or audio data taken by a video camera, not shown, is taken in a real-time manner, and is provided to the encoder 10 also in a form of a monitoring signal.

In the present embodiment, as the wide band network NW1, an IP network of 100 Base-T or 10 Base-T, or so, is assumed, while, as the narrow band network NW2, a radio LAN, an ISDN circuit, a PHS circuit or so, is assumed, for example.

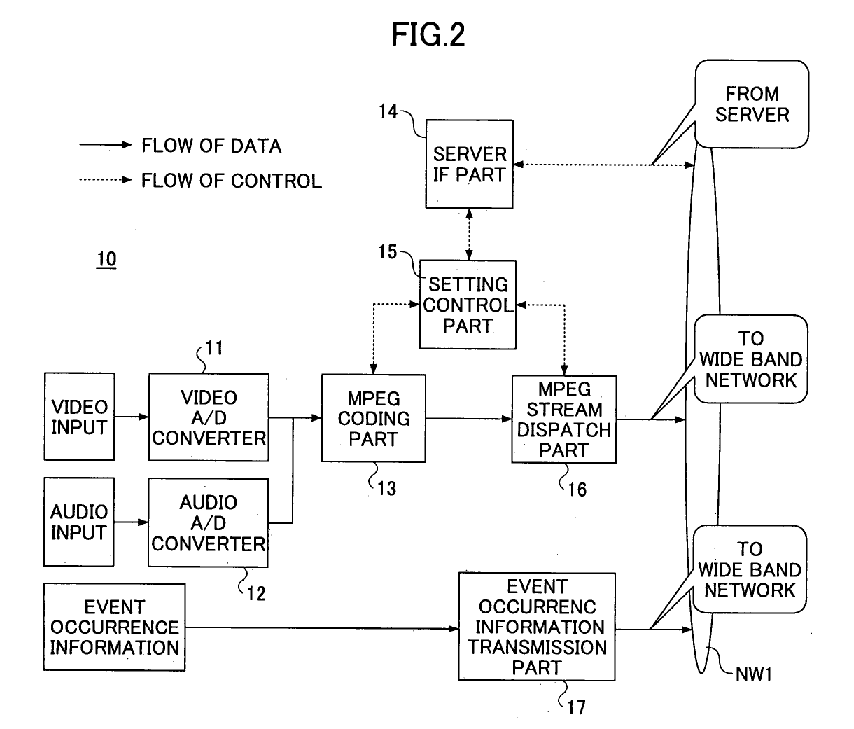

FIG. 2 shows a block diagram of the above-mentioned MPEG encoder 10. This MPEG encoder 10 includes a video A/D converter 11 performing analog-to-digital conversion on input video, an audio A/D converter 12 performing analog-to-digital conversion on input audio, an MPEG coding part 13 performing MPEG coding on an input digital video/audio signal, an MPEG stream dispatch part 16 dispatches in a real-time manner a coded MPEG stream through the network, an even occurrence information transmitting part 17 receives a signal reporting that some event has occurred externally and dispatches it through the network NW1, a server IF part 14 accepting a setting request from a server 100 or a stored image acquisition request, and a setting control part 15 which controls, according to a setting request by the server 100, the MPEG coding part 13, MPEG stream dispatch part 16 and event occurrence information transmitting part 17.

As to initial device setting of the MPEG encoder 10, the server IF part 14 receives a coding mode, a live dispatch address or so from the server 100, the setting control part 15 interprets it, sets the coding mode in the MPEG coding part 13, and sets the live dispatch address in the MPEG stream dispatch part 16. After that, video/audio data provided externally as mentioned above is converted into a digital signal via the respective one of the A/D converters 11 and 12, and then, the MPEG coding part 13 performs coding thereon with the coding mode set by the server as mentioned above. The thus-obtained coded MPEG stream is dispatched in a real-time manner through the network NW1. Further, in case a signal as event occurrence information is provided externally as mentioned above and is received, the information is dispatched through the network NW1 from the event occurrence information transmitting part 17.

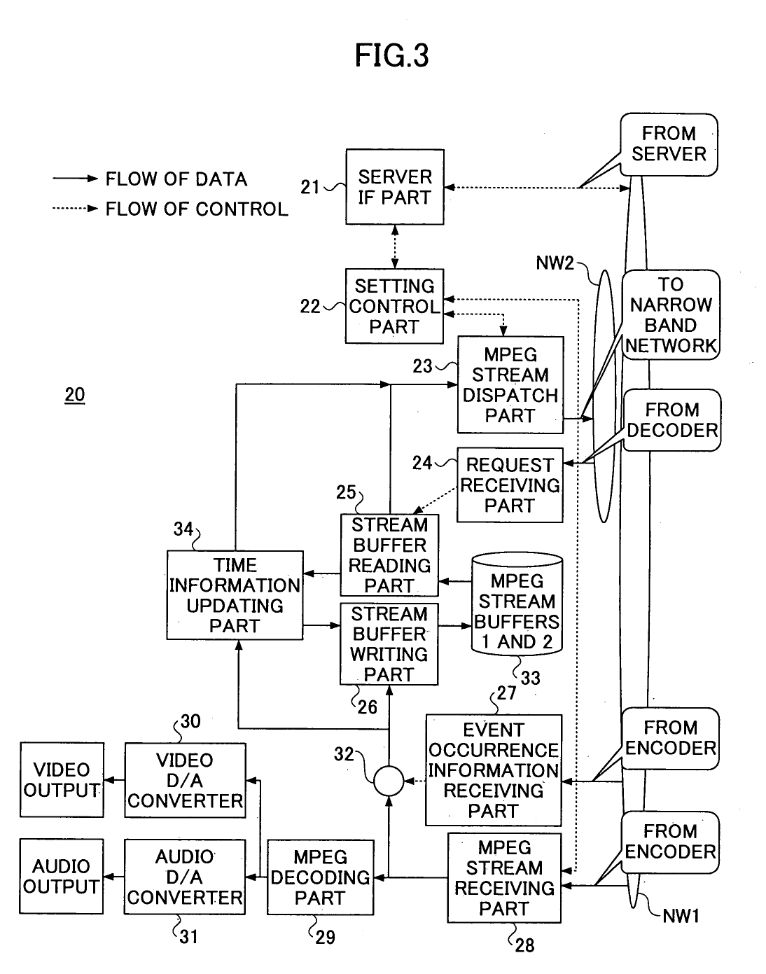

FIG. 3 shows a block diagram of the MPEG transcoder 20 mentioned above. This transcoder 20 includes an MPEG stream receiving part 28 receiving in a real-time manner an MPEG stream from the MPEG encoder 10, an MPEG decoding part 29 decoding the received MPEG stream, a video D/A converter 30 converting the decoded digital video data into analog video data, an audio D/A converter 31 converting the decoded digital audio data into analog audio data, a selecting switch 32 for selecting as to whether or not the received MPEG stream is dispatched through the narrow band network NW2, a MPEG stream buffer 33 once storing the received MPEG stream, a stream buffer writing part 26 writing the received MPEG stream into the MPEG stream buffer 33, a stream buffer reading part 25 reading out the MPEG stream once stored in the MPEG stream buffer 33, a time information updating part 34 updating the time information of the MPEG stream by a manner as will be described later, an MPEG stream dispatch part 23 dispatching the MPEG stream read out from the MPEG stream buffer 33 through the narrow band network NW2, an event occurrence information receiving part 27 receiving the event occurrence information from the MPEG encoder 10, a request receiving part 24 accepting a time request from the MPEG decoder 40 for the MPEG stream to be sent out as will be described later, a server IF part 21 accepting a setting request from the server 100, and a setting control part 22 which controls the MPEG stream receiving part 22 and the MPEG stream dispatch part 23 according to a setting request given by the server 100.

Initial device setting of the transcoder 20 is performed as follows: Live dispatch address/live receiving address received from the server 100 are interpreted by the setting and control part 22, and these addresses are then set in the MPEG stream dispatch part 23 and the MPEG stream receiving part 28, respectively. After that, the MPEG stream received by the MPEG stream receiving part 28 is decoded by the MPEG decoding part 29 according to the MPEG standard, and then, reproduced into video or audio information in a visible or audible state through the video and audio D/A converters 30 and 31.

On the other hand, when the event occurrence information receiving part 27 receives even occurrence information from the MPEG encoder 10, and thus, it is recognized that some event has occurred, the selecting switch 32 is turned, and thus, the received MPEG stream is written into the MPEG stream buffer 33 by the stream buffer writing part 26. The stream buffer reading part 25 reads out the MPEG stream from the MPEG stream buffer 33, and the time information thereof is updated as is necessary by the time information updating part 34, and then, the MPEG stream is dispatched through the narrow band network NW2 by the MPEG stream dispatched part 23. Thus, dispatched of the MPEG stream is executed.

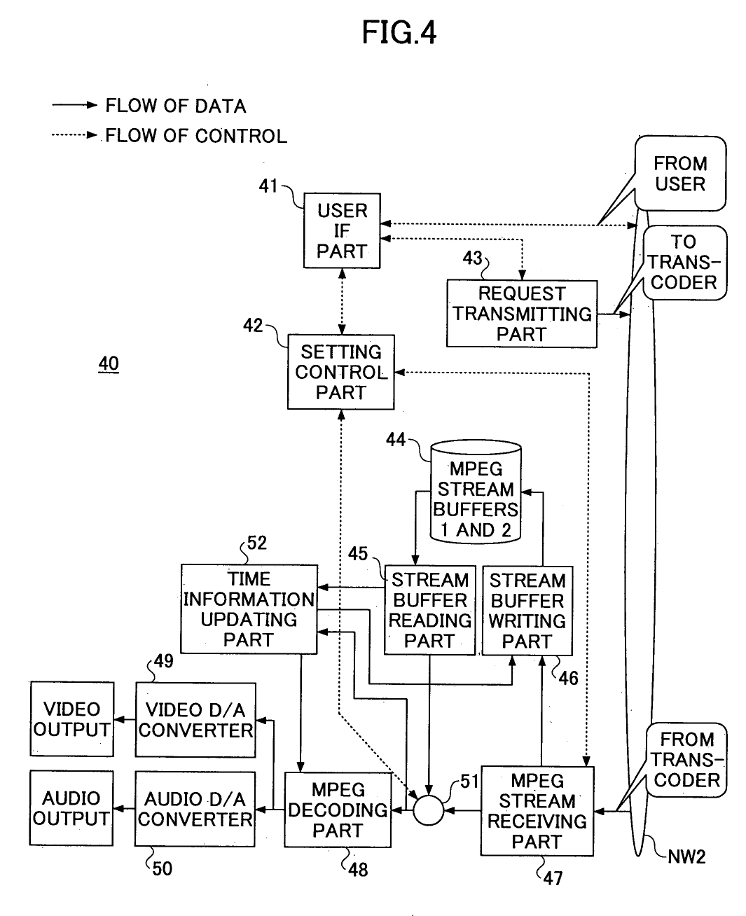

FIG. 4 shows the above-mentioned MPEG decoder 40. The MPEG decoder 40 includes an MPEG stream receiving part 47 receiving in a real-time manner an MPEG stream from the MPEG transcoder 20, an MPEG decoding part 48 decoding according to the MPEG standard the received MPEG stream, a video D/A converter 49 converting the thus-decoded digital video data into analog video data, an audio D/A converter 50 converting the thus-decoded digital audio data into analog audio data, an MPEG stream buffer 44 storing the received MPEG stream, a stream buffer writing part 46 writing the received MPEG stream into the MPEG stream buffer 44, a stream buffer reading part 45 reading out the MPEG stream from the MPEG stream buffer 44, a time information updating part 52 updating the time information of the MPEG stream in a manner which will be described later, a selecting switch 51 for selecting which one of the MPEG stream which is currently received and the MPEG stream which is already stored in the MPEG stream buffer 33 is to be decoded, a request transmitting part 43 issuing a time request to the MPEG transcoder for the MPEG stream to be brought therefrom, a user IF part 41 accepting a setting request from a user, and a setting control part 42 controlling according to the setting request given by the user the MPEG receiving part 47 and the selecting switch 51 accordingly.

Initial device setting of the above-described decoder is performed as follows: A live receiving address designated by the user is interpreted by the setting and control part 42, and is set in the MPEG stream receiving part 47. A MPEG stream received by the MPEG stream receiving part 47 is decoded according to the MPEG standard by the MPEG decoding part 48, and is reproduced into visible or audible information through the video or audio D/A converter 49 or 50. On the other hand, the received MPEG stream is written into the MPEG stream buffer 44 by the stream buffer writing part 46. The thus-stored received MPEG stream can be decoded by the MPEG decoding part according to the MPEG standard in response to the user's request, and reproduced into visible or audible information through the video or audio D/A converter 49 or 50.

The first embodiment of the present invention having the above-described configuration will now be described in detail.

According to the present embodiment, a high rate coded MPEG stream dispatched through the wide band network NW1 from the MPEG encoder 10 is further dispatched by the MPEG transcoder 20 through then the narrow band network NW2. Thus, through the narrow band network NW2, the thus-dispatched MPEG stream is received by the MPEG decoder 40, and after that, quick reproduction as quickly as possible can be achieved.

It is assumed that the MPEG encoder 10 connected to the wide band network NW1 continues to dispatch an MPEG stream encoded according to the coding mode designated by the server 100 through the wide band network NW1. Further, when event occurrence information is input externally, the event occurrence information is dispatched through the wide band network NW1 from the event occurrence information transmitting part 17. As a transmission format applied for transmitting the event occurrence information, any type of one can be applied as long as the dispatched information can be properly received and interpreted by the reception end.

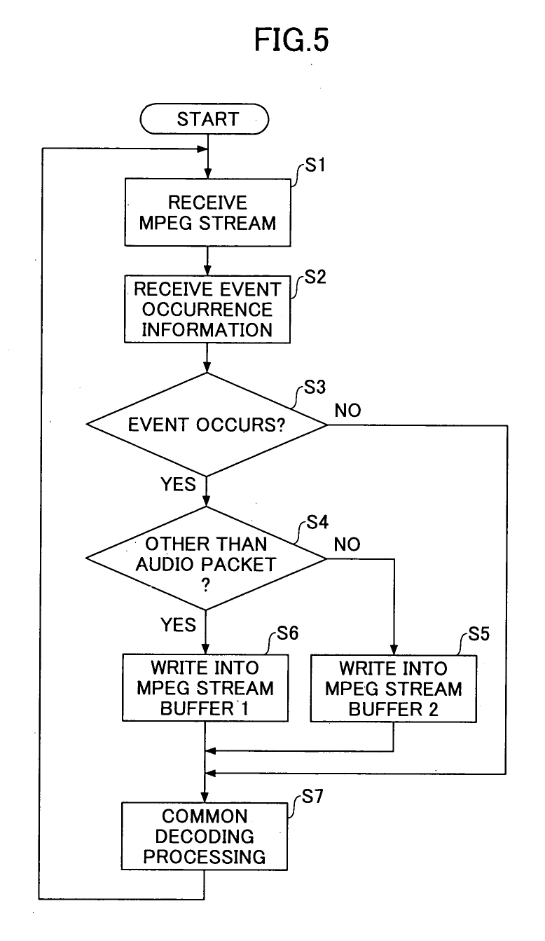

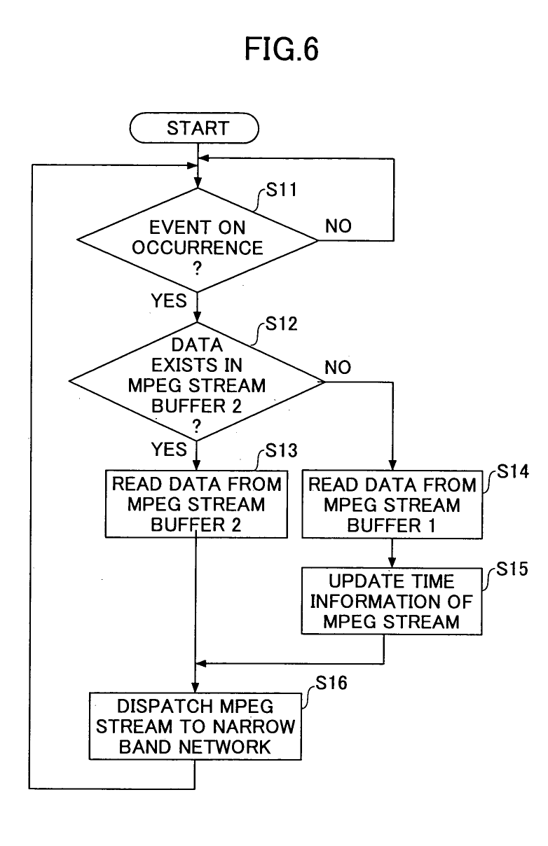

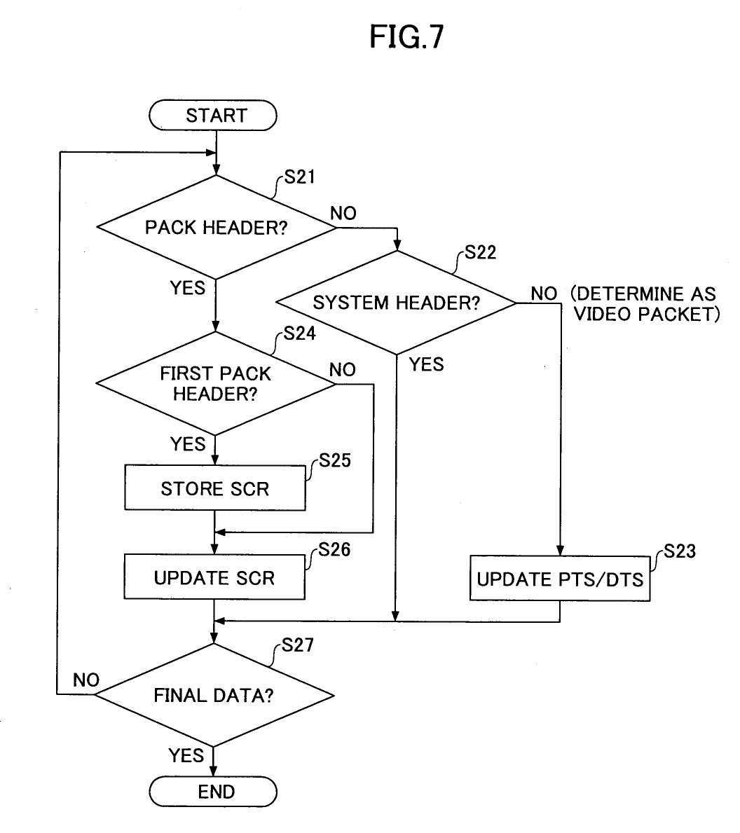

FIG. 5 shows a sequence at a time of receiving in the transcoder 20, FIG. 6 shows a sequence at a time of transmission in the transcoder 20, and FIG. 7 shows a sequence at a time of time information updating. With reference to these figures, a function of dispatch operation in the transcoder 20 will be described. In the present embodiment, it is assumed that an MPEG stream only including video data is dispatched to the MPEG transcoder 20 through the wide band network NW1.

First, receiving processing in the transcoder 20 will now be described with reference to FIG. 5. First, in Step S1, an MPEG stream dispatched through the wide band network NW1 is received in a packet unit or in a frame unit. Simultaneously, event occurrence information is received through the wide band network NW1 in Step S2. When it is recognized therefrom that some event has occurred, the received packet/frame of MPEG stream is stored in the MPEG stream buffer 33 in Steps S4, S5 and S6. In this example, it is assumed that no audio data exists in the received MPEG stream as mentioned above. Accordingly, the received MPEG stream is written into a video buffer part of the MPEG stream buffer 33, in Step S6. Furthermore, commonly, it is assumed that the MPEG transcoder 20 is installed at a location such as a video monitoring center or so. In such a case, the received MPEG stream is decoded according to the MPEG standard by the MPEG decoding part 29, and then, is reproduced from a TV monitor or so through video/audio D/A converters 30 and 31.

Transmission processing in the transcoder 20 will now be described with reference to FIG. 6. The transmission processing is executed independently from the above-described receiving processing. First, in case no even occurs (No in Step S11), no operation is performed. When an event occurs (Yes), it is determined whether or not audio data is stored in an audio buffer part of the MPEG stream buffer 33 in Step S12. In this example, it is assumed that no audio data exits, and thus, no audio data is stored (No in Step S12). Accordingly, data reading is performed only from the video buffer part of the MPEG stream buffer 33 in Step S14. In the video buffer part in the MPEG stream buffer 33, system information such as a system header or video data is stored.

In the MPEG stream, the time information such as the above-mentioned time reference value SCR, time management information for reproduction PTS, and time management information for decoding DTS are set. If these time information are dispatched as they are through the narrow band network NW2, as the data rate is reduced according to the band constriction rate accordingly, data transfer delay occurs as mentioned above. As a result, the MPEG stream cannot be received by the MPEG decoder 40 in prescribed timing, thus, as mentioned above, mismatch occurs between these time information and the SystemClock in the decoding end (apparatus), and as a result, proper reproduction may not be achieved. In order to solve this issue, in the MPEG transcoder 20 in the embodiment of the present invention, the above-mentioned time information is updated before the MPEG stream is dispatched through the narrow band network NW2 to the decoder 40.

The time information updating processing in the transcoder 20 will now be described with reference to FIG. 7. First, it is determined in Steps S21 and S22 whether data read out from the MPEG stream buffer 33 is a pack header, a system header or a video packet. In this case, it is assumed that the MPEG stream buffer 33 does not store therein audio packets. When the determination result is a packet header (Yes in Step S21), the first SCR occurring after the above-mentioned specific event occurs is stored. That is, the first SCR after the event occurs is stored as “SCR_{I}” in Step S25. In the other case (No in Step S24), the SCR value read out from the MPEG buffer 33 is stored as “SCR_{B}”.

Next, in Step S26, updating of SCR is performed by the time information updating part 34. It is assumed that the coded rate in the MPEG stream coded by the MPEG encoder 10 is “RATE_{B}”, while the available circuit transfer rate in the narrow band network NW2 is assumed as “RATE_{N}”. Then, the SCR value in the MPEG stream to be dispatched through the narrow band network NW2 is replaced by the value obtained from the following formula:

SCR_{I}+((SCR_{B}−SCR_{I})×(RATE_{B}/RATE_{N}))

That is, the time information SCR is extended or delayed by the amount corresponding to the ratio between the data rate in the coded stream and the available data transfer rate in the narrow band network NW2. In the example of FIG. 16, RATE_{B}/RATE_{N}=3. This corresponds to triple band constriction. In the packet on the line 2 of the table in FIG. 16, SCR_{B}=684 msec. with respect to SCRᵢ=666 msec. Accordingly, the above-mentioned formula becomes:

666+((684−666)×3)=720 (msec.)

Thus, the value after tripling conversion shown in the right-hand table in FIG. 16 is obtained.

Similarly, in case where the received data is a video packet (No in Step S22), assuming that the PTS value read out from the MPEG stream buffer 33 is PTS_{B} and the DTS value is DTS_{B} therefor, the time information updating part 34 replaces the PTS value and the DTS value in the MPEG stream to be dispatched through the narrow band network NW2 with the values obtained from the following formulas in Step S23:

SCR_{I}+((PTS_{B}−SCR_{I})×(RATE_{B}/RATE_{N}))

SCR_{I}+((DTS_{B}−SCR_{I})×(RATE_{B}/RATE_{N}))

That is, each of the time information PTS and DTS is extended or delayed respectively by the amount corresponding to the ratio of the data rate in the coded stream with respect to the available data transfer rate in the narrow band network NW2. In the packet on the line 9 of the table in FIG. 16, PTS_{B}=DTS_{B}=906 msec. with respect to SCRᵢ=666 msec. Accordingly, each of the above-mentioned formulas becomes:

666+((906−666)×3)=1386 (msec.)

Thus, the value after the tripling conversion shown in the right-hand table in FIG. 16 is obtained.

By repeating the processing (the loop of Steps S21 through S27), the time information in the relevant MPEG stream is updated in sequence, and as a result, the time information (time stamps) after the conversion (in the right-hand table in FIGS. 16 and 17) is obtained, for example. In the present embodiment, the time information in the respective headers and packets are updated according to the band constriction rate appropriately. Thereby, even in a case where the data arrival time at the transmission destination is delayed as a result of the reduction in the data transfer rate according to the band constriction, the data positively arrives at the transmission destination at the respective designated time which has been thus extended or delayed by the above-mentioned time information updating processing. Accordingly, it is possible to avoid a situation, which would otherwise occur, in which the relevant data would not arrive at the transmission destination so that mismatch would occur between the SystemClock in the decoding end and the designated time information.

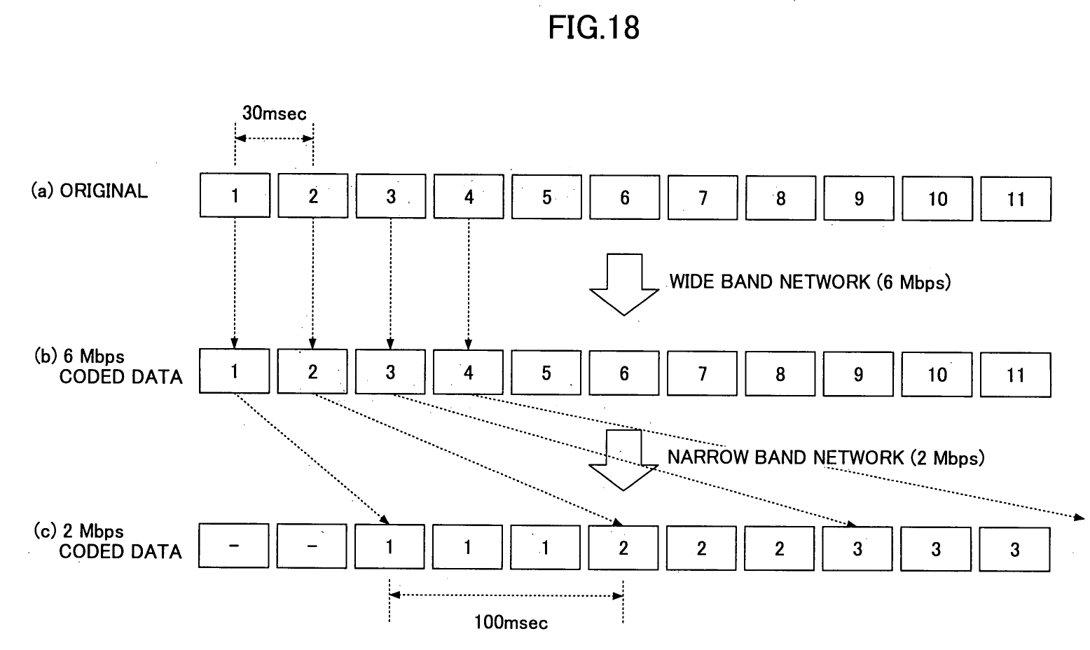

Accordingly, at the end of the MPEG decoder 40, proper reproduction of video can be executed immediately after the arrival of each frame of the data stream through the network NW2. However, as shown in FIG. 18, as a result of the above-mentioned extension of the time information for each frame due to the time information updating processing, the reproduction speed is slowed down accordingly.

FIG. 18 illustrates a change in video reproduction state actually occurring in this case as an example. As shown, an original (shown in FIG. 18, (a)) is a stream for reproducing image frames with the interval of 33 msec. In case this stream is coded into an MPEG stream in 6 Mbps as shown in FIG. 18, (b), reproduction of the image stream is achieved in the same rate. However, when the time information in the stream is extended according to the triple band constriction into the narrow band of 2 Mbps as in the above-described first embodiment of the present invention, the reproduction interval is extended thrice from 33 msec., which is same as that in the original, into 100 msec. when reproduction is executed according to the time information thus updated and extended. As a result, the video reproduction speed becomes one third accordingly.

A coded data stream transmission system in a second embodiment of the present invention will now be described. In the system in the first embodiment described above, the storage capacity of the MPEG stream buffer 33 in the MPEG transcoder 20 should have an increased size when the data amount received through the wide band network NW1 increases and data coded at a high bit rate should be dispatched out through the narrow band network NW2. In other words, assuming a data transmission time period needed for transmitting data through the wide band network NW1 at a time of a specific event occurs as T, the data storage capacity size required for the MPEG stream buffer 33 in the MPEG transcoder 20 is calculated by the following formula:

(RATE_{B}−RATE_{N})×T

That is, as the re-transmission is performed after the data transmission rate is reduced in the transcoder 20, a difference occurs between the data amount received from the MPEG encoder 10 and the data amount transmitted out through the narrow band network NW2, and the data amount corresponding to this difference should be temporarily stored in the MPEG stream buffer 33.

Basically, the maximum data transmission time period through the wide band network NW1 at a time of event occurrence should be determined such as to prevent the MPEG stream buffer 33 from overflowing during the period. However, the storage capacity in the MPEG stream buffer 33 may not be sufficient considering that an unexpected situation may occur, i.e., for a case where data transmission during a long time period is desired due to some cause, for a case where a proper coordination between a timing at which an event occurrence signal is received externally and a timing of data processing currently being executed in the transcoder 20 cannot be achieved, or so. In such a case, the MPEG transcoder 20 should discard/delete the overflowing data amount to be processed for the purpose of avoiding a worst result such as an emergency shutdown or so.

As being well-known, the MPEG stream is formed of intra-frame coded image I pictures, inter-frame forward-directional predictive coded image P pictures and both-directional predictive coded image B pictures. A group of pictures started by the I picture is called a GOP (Group Of Picture). Thereamoung, the I picture can be decoded alone, while the top I picture in the GOP is needed for decoding the other P pictures/B pictures in the GOP.

As thus the I picture needs no surrounding pictures for decoding it, a stream obtained from thinning out of the P/B pictures provides a perfect image quality by the I picture while frames of the P/B pictures are omitted. Accordingly, the image quality can be maintained at a time of reproduction as for the frames of the I pictures. Thus, according to the second embodiment, in addition to the above-mentioned functional configuration of the first embodiment, in case where the amount of data stream which should be stored in the MPEG stream buffer 33 becomes too large so that the data storage capacity size is insufficient therefor, only the I pictures are stored in the MPEG stream buffer 33 as long as the capacity size in the MPEG streams buffer 33 is sufficient for storing only the I pictures given. Furthermore, according to the second embodiment, in case such a storage capacity insufficiency situation becomes worth so that even the I pictures cannot be stored in the MPEG stream buffer 33, the entire GOP given is discarded.

The MPEG video packet includes a sequence layer, a GOP layer, a picture layer, a slice layer, a macro-block layer and a block layer. In the picture layer, a PCT (Picture Coding Type) is prepared indicating a picture type. By this information, it is possible to determine whether a given packet belongs to the I picture, the P picture or the B picture.

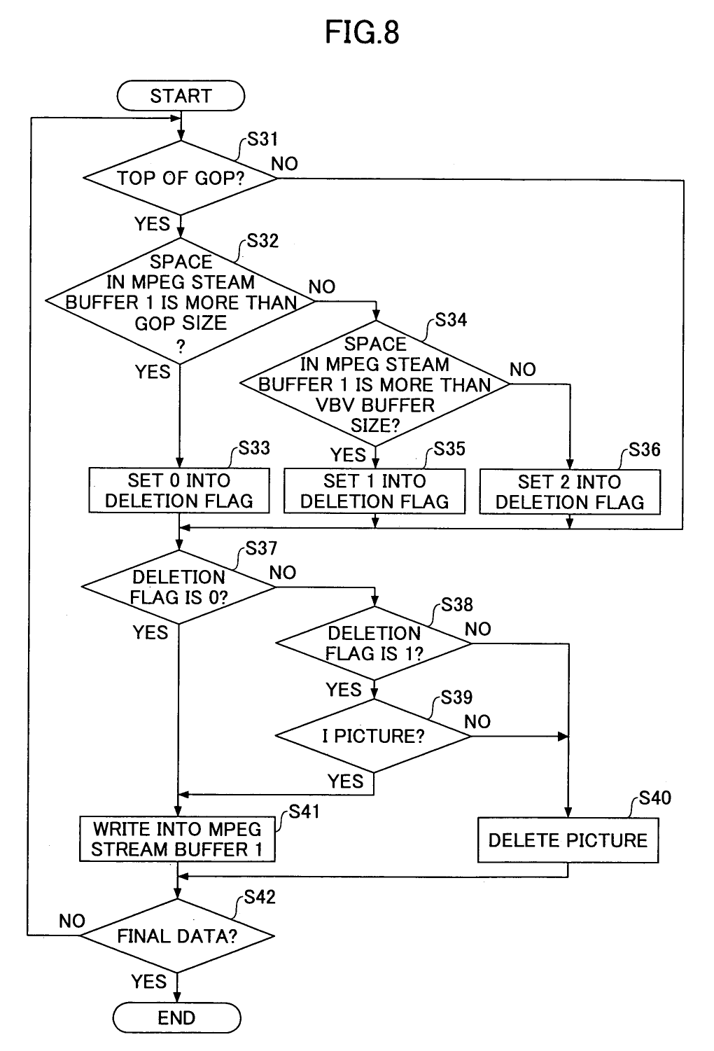

FIG. 8 shows an operation flow chart embodying the above-mentioned picture discard/deletion processing in the transcoder 20 according to the second embodiment. With reference thereto, an MPEG stream buffer management method in the MPEG transcoder 20 according to the second embodiment will be described. In the receiving sequence in the MPEG transcoder 20 illustrated with reference to FIG. 5, the picture discard sequence shown in FIG. 8 is inserted immediately before the operation of writing stream data into the MPEG stream buffer 33.

First, in Step S31, it is determined whether or not the received data of the MPEG stream corresponds to the top of a GOP. In case where it is the top of a GOP (Yes in Step S31), it is determined in Step S32 where or not the remaining storage capacity (available data storage amount) in the buffer 33 is not less than a predetermined GOP size. The predetermined GOP size is obtained, for example, from multiplying the following value to the coded bit rate in the MPEG encoder 10:

(the number of pictures included in one GOP)/30

where approximately 30 pictures per second are reproduced in a standard video reproduction process.

When the remaining storage capacity in the MPEG stream buffer 33 is not less than the GOP size (Yes), a predetermined deletion flag is set as “0” (Step S33). In the other case (No), the remaining storage capacity in the MPEG stream buffer is compared with a predetermined VBV buffer size in Step S34. The predetermined VBV buffer size is previously set in the sequence layer in the MPEG stream, and shows the maximum value of one picture. In case where the remaining storage capacity in the MPEG stream buffer 33 is not less than the VBV buffer size (Yes), the deletion flag is set as “1” in Step S35. In the other case (No), the deletion flag is set as “2” in Step S36.

In case where the deletion flag is 0 (Yes in Step S37), this means that at least one GOP can be stored in the MPEG stream buffer 33. Accordingly, the entire GOP given is written into the MPEG stream buffer 33 in Step S41. when the deletion flag is 1 (No in Step S37 and also Yes in Step S38), this means that only the I picture in the GOP can be stored in the MPEG stream buffer 33. Accordingly, only the I picture given is written thereto (in Steps S39 and S41). When the deletion flag is 2 (No in Step S38), this means that even one picture cannot be stored in the MPEG stream buffer 33. Accordingly, the entire GOP given is discarded in Step S40. These operations (the loop of Steps S31 through S42) are repeated until the received data is completed.

According to the above-described processing according to the second embodiment of the present invention, even in a case where a proper coordination cannot be achieved between externally input even occurrence signal processing and current data processing in the apparatus for example, the MPEG transcoding processing can be proceeded with without causing overflow in the MPEG stream buffer 33, and as a result, in the MPEG decoder 40 which receives data from the MPEG transcoder 20, it is possible to reproduce video data without causing a serious error such as remarkable lacking in video images or so which would otherwise occur due to the overflow.

A third embodiment of the present invention will now be described. In the above-described first and second embodiments, it is assumed that the given MPEG stream includes only video data. However, according to the third embodiment, it is assumed that a given MPEG stream may include both video data and audio data.

Video data has a feature such that, even if a reproduction speed is slowed down to some extent, a human being can recognize the video contents without fail. On the other hand, in case of audio data, when a reproduction speed is much slowed down, or intermittent reproduction is performed, a human being may not precisely recognize the contents thereof. Assuming that the present invention is applied to the accident monitoring system as mentioned above or so, there may be a need such that at least a sound of the accident should be obtained in a cause where some accident occurs. Therefore, according to the third embodiment, audio data is dispatched from the transcoder 20 immediately after it is received there through the narrow band network NW2 in prior to dispatch of video data already stored in the MPEG stream buffer 33. Thereby, it is possible that reproduction of audio data is performed timely in a satisfactory condition in the receiving decoder 4.

According to the third embodiment, with regard to the above-mentioned processing, in the receiving processing in the transcoder 20, the received stream is stored in the MPEG stream buffer 33 in a manner such that the system header and video data are stored in the video buffer part included in the MPEG stream buffer while audio data is stored in the audio buffer part also included in the MPEG stream buffer 33 (see FIG. 5). In this regard, in each packet included in an MPEG stream, a stream ID (\mathring{4} in FIG. 14) is prepared for determining whether the packet belongs to an MPEG video stream or an MPEG audio stream. By this information, it is possible to determine whether the given data is video data or audio data.

According to the third embodiment, in the transmission processing in the transcoder 20, upon occurrence of an event, when data exists in the audio buffer part of the MPEG stream buffer 33 (Yes in Step S12 of FIG. 6), the data in the audio buffer part of the MPEG stream buffer 33 is first dispatched out through the narrow band network NW2 in Steps S13 and S16. On the other hand, when no data exists in the audio buffer part in the MPEG stream buffer 33 (No in Step S12), data (video data or the system header) stored in the video buffer part of the MPEG stream buffer 33 is dispatched out through the narrow band network NW2 in Steps S14, S15 and S16 of FIG. 6. As mentioned above, audio data is requested to be dispatched as soon as possible so as to be reproduced in a real-time manner to the utmost extent in the receiving decoder 40. Accordingly, no updating is performed on the time information such as SCR values and PTS values for the audio packets. In contrast thereto, as the audio data is thus dispatched in prior to the video data as mentioned above, the time information such as the SCR values and PTS values thereof should be shifted backward accordingly.

Specifically, assuming that the coded rate in the audio data is RATE_{A}, the SCR value, PTS value and DTS value in the MPEG stream of the video data dispatched out through the narrow band network NW2 should be updated into those calculated by the following formulas, respectively:

SCR_{I}+((SCR_{B}−SCR_{I})×((RATE_{B}+RATE_{A})/RATE_{N}))

SCR_{I}+((PTS_{B}−SCR_{I})×((RATE_{B}+RATE_{A})/RATE_{N}))

SCR_{I}+((DTS_{B}−SCR_{I})×((RATE_{B}+RATE_{A})/RATE_{N}))

Furthermore, if one data transfer size through the narrow ban network NW2 is too large, dispatch processing through the narrow band network NW2 should be delayed. In order to avoid such a delay, it is needed to reduce one data transfer size through the narrow band network NW2 with respect to one data transfer size received through the wide band network NW1, by the ratio between RATE_{N} and RATE_{B}, or more.

Thus, through the above-mentioned processing in the third embodiment, it is possible to reproduce the audio data in real-time manner in the decoder 40 which receives the data stream through the narrow band network NW2.

A fourth embodiment of the present invention will now be described. In the above-described first through third embodiments, proper reproduction of received video and audio data is achieved merely requiring a standard functional configuration in the MPEG decoder 40 which receives a data stream through the narrow band network NW2, as a result of the time information in the MPEG stream being appropriately updated in the MPEG transcoder 20.

On the other hand, a user has a need to again confirm the contents once reproduced already. In order to respond to this request, stream storage processing is needed also in the MPEG decoder 40. However, if the MPEG stream buffer provided in the MPEG decoder 40 stores therein the MPEG stream having the time information extended and updated as mentioned above, as it is, video reproduction speed is also slowed down in case of again reproducing the thus-stored contents according to the thus-extended time information also in this case unnecessarily. The fourth embodiment has been devised so as to solve this issue. According to the fourth embodiment, the MPEG stream thus once stored in the decoder 40 in the state in which the time information is extended and updated is again updated to one with which the contents can be reproduced at a real speed.

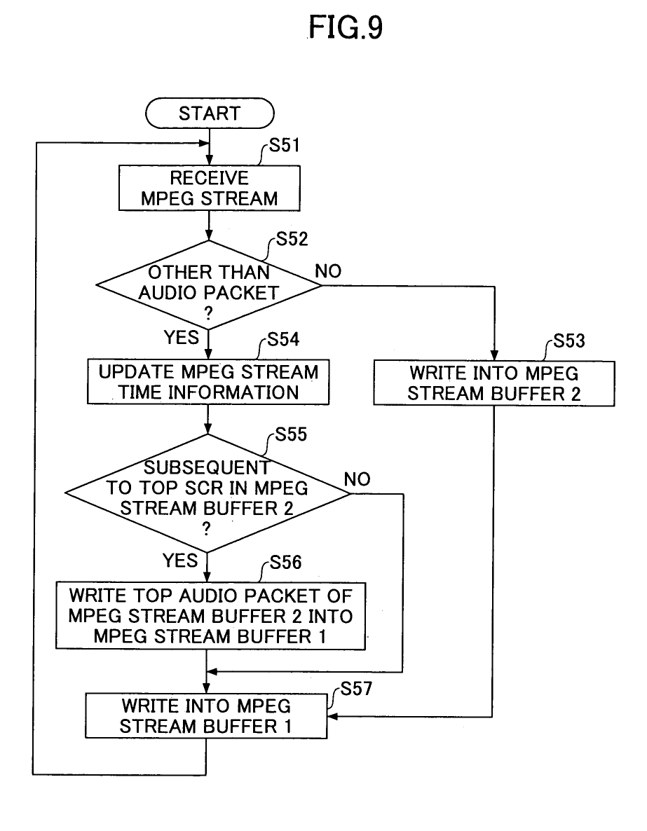

FIG. 9 shows a receiving sequence in the MPEG decoder 40 according to the fourth embodiment. With reference thereto, an MPEG stream storage processing method in the MPEG decoder connected with the narrowband network according to the fourth embodiment will now be described.

First, in case where an MPEG stream received through the narrow band network NW2 is of an audio packet (in Step S51 and Yes in Step S52), as the MPEG transcoder 20 which is the transmission source of this MPEG stream has then not updated the time information of this stream since it is the audio packet as mentioned above, this received stream is written into the stream buffer 44 as it is in Step S53. On the other hand, when the received MPEG stream is other than an audio packet (No in Step S52), the time information thereof has been updated in the MPEG transcoder acting as the transmission source, and thus, the time information updating part 52 in the decoder 40 should perform time information restoration processing for the received MPEG stream in Step S54.

Specifically, the first SCR is stored as SCR_{I}. Then, in the other case, the SCR values, PTS values and DTS values in the received MPEG stream are replaced by the values calculated by the following formulas, respectively, assuming that the original SCR value, PTS value and DTS value are SCR_{N}, PTS_{N} and DTSₙ, respectively, the coded rate in the data other than the audio data encoded in the MPEG encoder 10 initially is RATE_{B}, the coded rate in the audio data encoded in the MPEG encoder 10 initially is RATE_{A}, and the circuit transfer rate in the narrow band network NW2 is RATE_{N}:

SCR_{I}+((SCR_{N}−SCR_{I})×(RATE_{N}/(RATE_{B}+RATE_{A}))

SCR_{I}+((PTS_{N}−SCR_{I})×(RATE_{N}/(RATE_{B}+RATE_{A}))

SCR_{I}+((DTS_{N}−SCR_{I})×(RATE_{N}/(RATE_{B}+RATE_{A}))

That is, as a result of this time information restoration processing, the respective time information, i.e., SCR, PTS and DTS are returned to ones same as those occurring before they are updated in the MPEG transcoder 20.

Next, when an audio packet is stored in an audio buffer part of the MPEG stream buffer 44, the SCR value in the data of the received MPEG stream updated or restored as mentioned above and the SCR value in the audio packet stored at the top of the audio buffer part of the MPEG stream buffer 44 are compared with one another in Step S55. When it is determined that the SCR value in the audio packet stored indicates an earlier time (Yes), the audio packet stored at the top in the audio buffer of the MPEG stream buffer 44 is read out therefrom and written into a video buffer part of the MPEG stream buffer 44 in Step S56. After that, the relevant data of the received MPEG stream is also written into the video buffer part of the MPEG stream buffer 44 in Step S57. In the other case (No in Step S55), Step S56 is skipped over, and thus, the relevant data of the received MPEG stream is written into the video buffer part of the MPEG stream buffer 44 in Step S57. Thus, according to the SCR values returned to the time information same as those before they are updated in the MPEG transcoder 20, the order of data is changed (re-arranged) appropriately, and the data including the audio data and video data are written into the video buffer of the MPEG stream buffer 44 in the proper temporal order so that video information and audio information can be reproduced simultaneously by reading out the data from the video buffer part of the MPEG stream buffer 44.

Thus, according to the processing according to the fourth embodiment, in the MPEG stream buffer 44 in the MPEG decoder 40, the same stream as that initially dispatched by the MPEG encoder 10 is stored finally. Accordingly, it is possible to obtain a reproduction thereof in a normal condition in case of reproducing the once stored stream for the purpose of confirmation or so. In the above description, an example where the processing is performed during receiving the data stream through the network has been mentioned. However, it is not necessary to be limited to this example. For another example, it is possible that the transmitted stream is once received, and then, after that, it is read out, and the above-described time information restoration processing and data re-arrangement (ordering change) processing are performed.

A fifth embodiment according to the present invention will now be described. In the above-described first through fourth embodiments, a received stream can be reproduced with a high image quality with a minimum delay. There, even in a case where a large size of data is received through a narrow band network, it is not necessary to wait for a completion of the entire stream nor to thinning out video frames before dispatch. However, in these embodiments, once encoded MPEG stream is dispatched through a narrow band network providing a data transfer rate lower than the originally coded rate. Thereby, video reproduced in the decoder 40 is one in which a delay increases gradually, as shown in FIG. 18, (c), for example. In consideration of this issue, the fifth embodiment has been devised. According to the fifth embodiment, a user transmits, via the transcoder 40, a reproduction time designating request to the transcoder 20, and thereby, enables dispatch of a part of a MPEG stream having a desired time.

According to the fifth embodiment, a designated reproduction time designated by the user is defined as a time interval T_{R} (secs) measured from a just event occurrence occasion, where:

0≦T_{R}≦T_{C}

where T_{C} denotes a time interval between the event occurrence occasion and the current time. This designated reproduction time is requested by the user who performs a monitoring work with a use of the MPEG decoder 40 for a predetermined event, for example.

The requested designated reproduction time is sent out toward the transcoder 20 via the request transmitting part 43 from the user IF part 41 in the decoder 40. In the MPEG transcoder 20, the designated reproduction time T_{R} is received via the request receiving part 28 from the MPEG decoder 40. There is a possibility that data relevant to the thus-requested time has been already transmitted from the transcoder 20. Accordingly, it is assumed that the MPEG stream even having been dispatched out should be left in the MPEG stream buffer 33 without being discarded. Thus, according to the fifth embodiment, the required size of the MPEG stream buffer 33 in the MPEG transcoder 20 is calculated by the following formula in case a data transmission time period through the wide band network NW1 at a time of the event occurrence is T:

RATE_{B}×T

In the transcoder 20, the following processing is performed. It is assumed that the first SCR value occurring after the event occurs is SCR_{I}. Here, it is assumed that the SCR value is expressed by a constantly counted up value corresponding 90 kHz, i.e., it is a value counted up 90,000 times per one second. The SCR values for the pack headers set in the system headers stored in the MPEG stream buffer 33 are searched for the SCR value which differs from the above-mentioned SCR_{I} by not less than 90,000×T_{R}. The thus obtained SCR value is stored as SCR_{J}. Then, the data in the MPEG stream buffer 33 having the SCR values later than the SCR_{J} are dispatched toward the MPEG decoder 40 in sequence. The respective time information, i.e., SCR value, PTS value and DTS value in the data stream thus dispatched in this case are updated by the values by the time information updating part 34 in the transcoder 20 calculated by the following formulas:

SCR_{J}+((SCR_{B}−SCR_{J})×(RATE_{B}/RATE_{N}))

SCR_{J}+((PTS_{B}−SCR_{J})×(RATE_{B}/RATE_{N}))

SCR_{J}+((DTS_{B}−SCR_{J})×(RATE_{B}/RATE_{N}))

The processing other than the above-described processing performed in the transcoder 20 is same as that in the above-described third embodiment.

According to the processing in the fifth embodiment, a user can control data which should be currently dispatched into data having a time which is advanced from that of the data currently being displaced or which is delayed from that of the data currently being dispatched, according to the user's desire. Accordingly, when an accumulated delay amount, occurring due to gradually increasing delay mentioned above with reference to FIG. 18, (c), increases to some extent, the user may advance the time of data to be currently dispatched (by designating the above-mentioned designated reproduction time interval T_{R}) so that the accumulated delay may be cancelled. This operation of advancing the time of data to be currently dispatched means to skip several frames which belong to the earlier or old timing. Then, if the user feels that the above-mentioned operation of skipping several frames belonging to the old timing has been performed too much, the user may return the time of data to be currently dispatched backward in time (by designating the above-mentioned designated reproduction time interval T_{R} shorter) so that frames in older timing may be reproduced. Thus, the user can see video in the most desirable time zone.

Thus, according to the present invention, in a transcoder for receiving a MPEG stream through a wide band network and transmitting it through a narrow band network, time information given to the MPEG stream is changed according to a transmission band width of a communication network applied for the transmission. Thereby, it is possible to dispatch the video contents transmitted in a state of high image quality with a reduced delay (without waiting for the completion of receiving the entire large sized data), also, without needing thinning out of frames before dispatch, through the narrow band network. As a result, in a receiving apparatus which then receives the data through the narrow band network, it is possible to start seeing the video contents simultaneously with the just time at which it is transmitted from the transmission source. Also, it is possible to receive all the frames and reproduce them. Thereby, even in a case where a plurality of video sources (encoders) exist simultaneously, a user can see the contents of each video source in sequence, without waiting for a completion of receiving the entire data stream from each video source, and then can terminate the reception from one video source to move to another video source rapidly thereamoung. Thus, the user can soon reach a certain video source which the user finally desires, and then, receive and reproduce the contents therefrom.

Furthermore, if an accumulated video delay time increases to much, it is possible to bring the latest video to be reproduced according to a user's request. Further, it is also possible to return backward to old frames for the purpose of confirmation or so. Thus, fine reproduction video time selection control can be achieved.

The present invention is not limited to the above-described embodiments, and variations and modifications may be made without departing from the claimed scope of the present invention.

The present application is based on Japanese priority application No. 2003-076336, filed on Mar. 19, 2003, the entire contents of which are hereby incorporated by reference.

What is claimed is:

1. A data processing system comprising:
a data transfer rate converting part converting a data transfer rate in a predetermined coded data stream;
a time information updating part updating time information which the predetermined coded data stream has, according to the data transfer rate conversion ratio applied in said data transfer rate converting part; and
a decoding device decoding the coded data stream for which the data transfer rate has been converted by said data transfer rate converting part and the time information is updated by said time information updating part, and
wherein:
said decoding device decodes the coded data stream for which the data transfer rate has been thus converted and the time information has been updated, in timing according to the time information which has been thus updated by said time information updating part.

2. The data processing system as claimed in claim 1, wherein:
the data transfer rate conversion performed by said data transfer rate converting part comprises reduction in the data transfer rate; and
the updating in the time information performed by said time information updating part comprises extension of the time indicated by the time information according to said reduction in the data transfer rate.

3. The data processing system as claimed in claim 1, wherein:
the coded data stream comprises video data comprising intra-frame coded image frames which can be decoded alone and predictive coded image frames for which data of the intra-frame coded frames is needed for decoding them; and
in a predetermined condition, a mode in which only the intra-frame coded image frames are transferred and are then decoded is applied

4. The data processing system as claimed in claim 1, wherein:
in case the coded data stream includes video data and audio data, the audio data is transferred in prior to transfer of the video data; and
the time information of the audio data is not updated and is transferred as it is.

5. The data processing system as claimed in claim 1, wherein:
said decoding device comprises a re-updating part which updates the once updated time information again so as to return it into the original state for the coded data stream for which the time information has been once updated by the time information updating part.

6. The data processing system as claimed in claim 1, further comprising a time designating part for designating a time for the coded data stream, and
wherein:
said time information updating part updates time information of a part of the coded data stream and transfers it, which part of the coded data stream belongs to a time zone starting after the time designated by said time designating part.

7. A data processing apparatus comprising:
a data transfer rate converting part converting a data transfer rate a predetermined coded data stream, and
a time information updating part updating time information which the predetermined coded data stream has according to a data transfer rate conversion ratio applied in said data transfer rate converting part, and
wherein:
the coded data stream for which the data transfer rate has been converted by said data transfer rate converting part and the time information is updated by said time information updating part is decoded by a transfer destination device, and, upon the decoding, the coded data stream for which the data transfer rate has been thus converted is decoded in timing according to the time information which has been thus updated by said time information updating part.

8. The data processing apparatus as claimed in claim 7, wherein:
the data transfer rate conversion performed by said data transfer rate converting part comprises reduction in the data transfer rate; and
the updating in the time information performed by said time information updating part comprises extension of the time indicated by the time information according to said reduction in the data transfer rate.

9. The data processing apparatus as claimed in claim 7, wherein:
the coded data stream comprises video data comprising intra-frame coded image frames which can be decoded alone and predictive coded image frames for which data of the intra-frame coded frames is needed for decoding them; and
in a predetermined condition, a mode in which only the intra-frame coded image frames are transferred is applied.

10. The data processing apparatus as claimed in claim 7, wherein:
in case the coded data stream includes video data and audio data, the audio data is transferred in prior to transfer of the video data; and
the time information of the audio data is not updated and is transferred as it is.

11. The data processing apparatus as claimed in claim 7, wherein:
in response to time information being designated for the coded data stream, said data transfer rate converting part converts a data transfer rate for a part of the coded data stream and said time information updating part updates the time information of said part of the coded data stream, which part of the coded data stream belong to a time zone starting after the time thus designated.

12. A data processing apparatus receiving a transferred coded data stream, and decoding and reproducing the coded data stream, wherein:
the transferred coded data stream has been transferred after time information thereof was updated according to a data transfer capacity of a data transfer path applied for transferring the coded data stream;
said apparatus comprises a time information re-updating part receiving the coded data stream, and updating the time information already once updated again so as to return it into the original one; and
said apparatus decodes the coded data stream for which the time information has been thus updated again by said time information re-updating part, according to the time information thus updated again by the time information re-updating part.

13. The data processing apparatus as claimed in claim 12, wherein:
in case the coded data stream comprises video data and audio data, the audio data is transferred in prior to transfer of the video data, and also the video data is transferred without having undergone updating of the time information thereof; and
said apparatus comprises an order rearranging part re-arranging appropriately the order of the video data and the audio data received according to the time information after being thus updated again by the time information re-updating part for the received coded data stream.

14. A data processing method comprising:
a data transfer rate converting step of converting a data transfer rate a predetermined coded data stream;
a time information updating step of updating time information which the predetermined coded data stream has, according to a data transfer rate conversion ratio applied in said data transfer rate converting step; and
a decoding step decoding the coded data stream for which the data transfer rate has been converted in said data transfer rate converting step and the time information is updated in said time information updating step, and
wherein:
in said decoding step, the coded data stream for which the data transfer rate has been thus converted is decoded in timing according to the time information which has been thus updated in said time information updating step.

15. The data processing method as claimed in claim 14, wherein:
the data transfer rate conversion performed in said data transfer rate converting step comprises reduction in the data transfer rate; and
the updating in the time information performed in said time information updating step comprises extension of the time indicated by the time information according to said reduction in the data transfer rate.

16. The data processing method as claimed in claim 14, wherein:
the coded data stream comprises video data comprising intra-frame coded image frames which can be decoded alone and predictive coded image frames for which data of the intra-frame coded frames is needed for decoding them; and
in a predetermined condition, a mode in which only the intra-frame coded image frames are transferred and are then decoded is applied

17. The data processing method as claimed in claim 14, wherein:
in case the coded data stream includes video data and audio data, the audio data is transferred in prior to transfer of the video data; and
the time information of the audio data is not updated and is transferred as it is.

18. The data processing method as claimed in claim 14, further comprising:
a re-updating step of updating the once updated time information again so as to return it into the original state for the coded data stream for which the time information has been once updated in said time information updating step, upon decoding the coded data stream.

19 The data processing method as claimed in claim 14, further comprising a time designating step of designating time information for the coded data stream, and
wherein:
for a part of the coded data stream belonging to a time zone starting after the time designated in said time information designating step, a data transfer rate is converted in said data transfer rate converting step, time information is updated in said time information updating step, and then the part of the coded data stream is transferred.
